(19) United States
(12) Patent Application Publication
(10) Pub. No.: US 2012/0109847 A1
(43) Pub. Date: May 3, 2012

(54) Lease Evaluation and Planning

(75) Inventor: Faith Terry Hemenway, Fort Mill, SC (US)

(73) Assignee: Bank of America Corporation, Charlotte, NC (US)

(21) Appl. No.: 12/938,269

(22) Filed: Nov. 2, 2010

(51) Int. Cl. G06Q 40/00

(52) U.S. Cl. 705/36 R

(57) ABSTRACT

According to one embodiment of the present invention, a method receives a request to facilitate an evaluation of lease data. The method determines one or more categories of lease data according to the request and retrieves the lease data associated with the determined categories. The method determines one or more rules to apply to the lease data, applies the rules, and communicates a report indicating results of applying the rules to the lease data.

### TECHNICAL FIELD OF THE INVENTION

The present invention relates generally to leases and more specifically to providing lease evaluation and planning.

### BACKGROUND OF THE INVENTION

A lease provides terms according to which a lessor rents property to a lessee. The lessor typically negotiates lease terms intended to yield a target level of performance. During the course of the lease, the lessor monitors the actual level of performance and plans modifications required to meet the target level of performance. Certain lessors, such as financial institutions, manage portfolios of many leases. Due to the large number of leases, planning particular lease terms required to yield a target level of performance for the overall portfolio is often complex.

### SUMMARY OF THE INVENTION

In accordance with the present invention, disadvantages and problems associated with lease evaluation and planning may be reduced or eliminated.

According to one embodiment of the present invention, a method receives a request to facilitate an evaluation of lease data. The method determines one or more categories of lease data according to the request and retrieves the lease data associated with the determined categories. The method determines one or more rules to apply to the lease data, applies the rules, and communicates a report indicating results of applying the rules to the lease data.

Certain embodiments of the invention may provide one or more technical advantages. A technical advantage of one embodiment includes assimilating data for a number of leases. Another technical advantage includes categorizing leases in order to determine rules to apply for analyzing the leases. Assimilating data and/or categorizing the leases may allow for increased efficiency during lease evaluation and planning. Another technical advantage of an embodiment includes performing audits to identify changed data associated with the lease.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system that assimilates data to facilitate lease evaluation and planning;

FIG. 2 illustrates an example of a report used for lease evaluation and planning; and

FIG. 3 illustrates a flowchart for lease evaluation and planning.

### DETAILED DESCRIPTION OF THE INVENTION

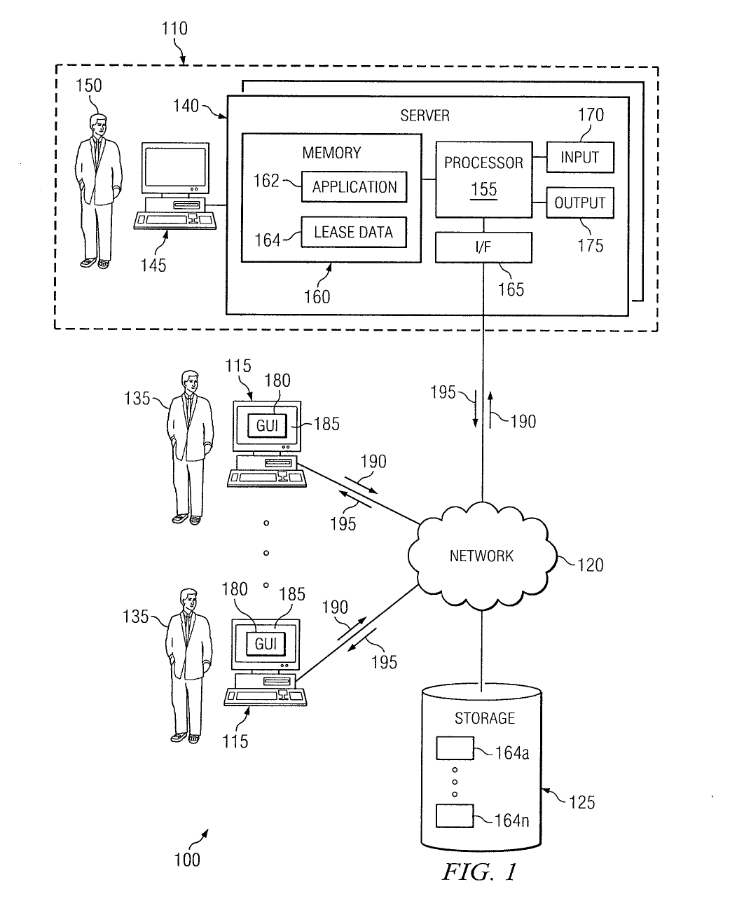

Embodiments of the present invention and its advantages are best understood by referring to FIGS. 1 through 3 of the drawings, like numerals being used for like and corresponding parts of the various drawings.

A lease provides terms according to which a lessor rents property to a lessee. The lessor typically negotiates lease terms intended to yield a target level of performance. During the course of the lease, the lessor monitors the actual level of performance and plans modifications required to meet the target level of performance. Certain lessors, such as financial institutions, manage portfolios of many leases. Due to the large number of leases, planning particular lease terms required to yield a target level of performance for the overall portfolio is often complex. The teachings of the disclosure recognize that it would be desirable to manage data for a number of leases to allow the lessor to better evaluate lease performance and to better perform lease planning. FIGS. 1 through 3 below illustrate a system and method for lease evaluation and planning that may be used to efficiently manage a number of leases.

FIG. 1 illustrates a system 100 according to certain embodiments. System 100 may include an enterprise 110, one or more clients 115, a network storage device 125, one or more servers 140, and one or more users 135. Enterprise 110, clients 115, and network storage device 125 may be communicatively coupled by a network 120. Enterprise 110 is generally operable to provide report 195, as described below.

In general, one or more servers 140 may provide report 195 to users 135. User 135 provides a request 190 to server 140 via client 115. Server 140 then accesses lease data associated with one or more categories of leases indicated by request 190. Server 140 determines one or more rules to apply to the lease data and applies the rules. Server 140 then communicates report 195 to user 135 via client 115, report 195 indicates the results of applying the rules.

Client 115 may refer to any device that enables user 135 to interact with server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 185, microphone, keyboard, or any other appropriate terminal equipment usable by user 135. It will be understood that system 100 may comprise any number and combination of clients 115. User 135 utilizes client 115 to interact with server 140 to receive report 195, as described below. In some embodiments, user 135 may be a person that evaluates lease performance and plans future leases, such as an employee of a financial institution or other enterprise that rents property to lessees.

In some embodiments, client 115 may include a graphical user interface (GUI) 180. GUI 180 is generally operable to tailor and filter data entered by and presented to user 135. GUI 180 may provide user 135 with an efficient and user-friendly presentation of request 190 and/or report 195. GUI 180 may comprise a plurality of displays having interactive fields, pull-down lists, and buttons operated by user 135. GUI 180 may include multiple levels of abstraction including groupings and boundaries. It should be understood that the term GUI 180 may be used in the singular or in the plural to describe one or more GUIs 180 and each of the displays of a particular GUI 180.

In some embodiments, network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 125 may store any data and/or instructions utilized by server 140.

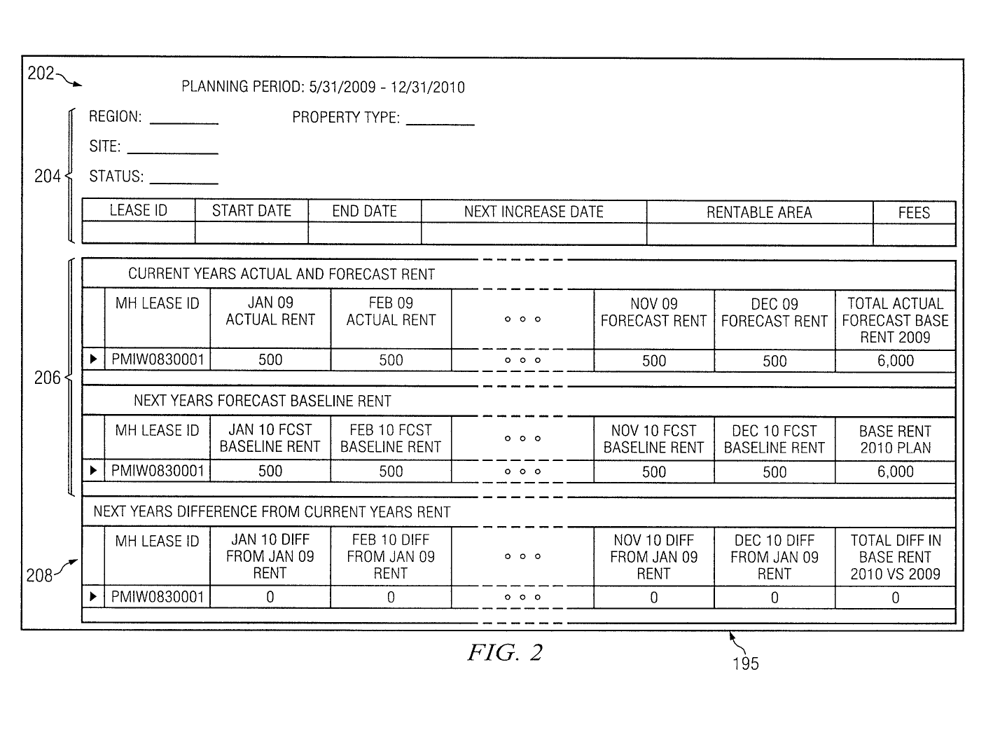

In the illustrated embodiment, network storage device 125 stores lease data 164a to 164n describing a plurality of leases. Lease data 164 may include any data suitable for describing a lease. As an example, lease data 164 may include expense data, such as base expenses and/or operating expenses. Expense data may refer to actual expense data for an elapsed time period or forecasted expense data for a future time period. Accordingly, expense data may be represented on a periodic basis, such as monthly, quarterly, semi-annually, or annually. Other examples of lease data include information used to characterize the lease, such as region, site, property type, status, lease identifier, lease term, lease start date, lease end date, next increase date, rentable area (e.g., square footage), rate (e.g., dollars per square foot), applicable fees, contact names, rent methodology, a master lease identifier indicating related leases, comments, and so on. Lease characteristics are described in more detail with respect to FIG. 2.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an administrator workstation 145, and an administrator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 140 receives lease data 164, categorizes lease data 164, applies one or more rules, and provides report 195 to users 135. In some embodiments, server 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

Server memory 160 is generally operable to store an application 162 and lease data 164. Application 162 generally refers to logic, rules, algorithms, code, tables, and/or other suitable instructions for performing the described functions and operations. Application 162 may access rules from server memory 160. Rules may indicate a category of lease data and an action to perform. Rules may be determined from request 190, pre-configured, or both. Pre-configured rules may be defined for an enterprise, an entity, a line of business, an individual user, and so on. As a first example, a line of business responsible for leasing properties in the South may define a rule to include all properties categorized in the Southern region. As a second example, a line of business responsible for leasing office properties may define a rule to exclude leases categorized as residential properties. As a third example, a line of business responsible for lease renewals may define a rule to send a notification identifying leases scheduled to expire within a pre-determined time period. As a final example, a rule may be defined to apply normalization techniques to the lease data in order to reflect a fair market rent evaluation. By analyzing lease data 164 according to the rules, application 162 may generate results that facilitate the ability of user 135 to evaluate the requested lease data. In some embodiments, application 162 facilitates preparing report 195 and communicating report 195 to users 135.

Server memory 160 communicatively couples to processor 155. Processor 155 is generally operable to execute application 162 stored in server memory 160 to provide report 195 according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through network 120 or other communication system that allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives request 190 from clients 115 and transmits report 195 to clients 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 140 using an administrator workstation 145. In some embodiments, administrator workstation 145 may be communicatively coupled to server 140 and may refer to any suitable computing system, workstation, personal computer such as a laptop, or any other device operable to process data. In certain embodiments, an administrator 150 may utilize administrator workstation 145 to manage server 140 and any of the data stored in server memory 160 and/or network storage device 125. In some embodiments, administrator 150 may authorize users 135 to interact with lease data 164 according to one or more access levels. For example, certain users 135 may be authorized to interact with lease data 164 according to a read-only access level. Read-only access allows user 135 to request and view reports 195, but does not allow the user to modify any lease data 164. Other users 135 may be granted increased authorization rights that allow for setting up rules, creating categories, and/or adding, modifying, or deleting lease data 164.

In an exemplary embodiment of operation, application 162, upon execution by processor 155, facilitates assimilating lease data 164 and communicates report 195 to users 135. Application 162 may facilitate assimilating lease data 164 in response to request 190. In some embodiments, user 135 submits request 190 on client 115 to request report 195. Request 190 may identify one or more categories of lease data 164 being requested. As an example, request 190 may request lease data 164 for leases categorized as having an active status. Request 190 may optionally include a planning period indicating the dates that user 135 requests to evaluate. Request 190 may optionally describe the type of information user 135 requests to evaluate. For example, the user may request forecasted expenses and/or certain planning information. In response to user 135 requesting report 195, application 162 may request lease data 164 from network storage device 125.

Application 162 determines rules to be applied to lease data 164. Application 162 may determine the rules to apply according to a category in the request and/or according to pre-configured criteria. As an example, user 135 may request forecasted expenses associated with properties in the Southern region. Application 162 determines to include lease data 164 associated with properties in the Southern region according to the request. Application 162 may also apply pre-configured rules. An example of a pre-configured rule may be to exclude lease data 164 associated with leases having an expired status with respect to the time period being planned. Application 162 applies the rules to lease data 164 to determine results to include in report 195 and sends report 195 to user 135 to communicate the requested data. FIG. 2 provides an example of report 195.

In some embodiments, user 135 may request application 162 to apply modifications to lease data 164. For example, user 135 may request modifications if the forecast data fails to satisfy a target performance level. An example of a modification may be to increase the rate (e.g., dollars per square foot) for certain categories of leases. Upon receiving a request for a modification, application 162 applies the modification and updates report 195 accordingly. Application 162 communicates updated report 195 to user 135 so that user 135 may evaluate the effect of the modification. If the result of the modification is satisfactory, user 135 may recommend to implement the modification.

FIG. 2 illustrates an example of report 195 used for lease evaluation and planning. Report 195 may be generated by application 162 using lease data 164. In the example, report 195 describes a single lease, however, other reports 195 may aggregate data from multiple leases to provide planning information for a category of leases. Report 195 may include a planning period 202, lease characteristics 204, expense data 206, and planning data 208. Planning period 202 may refer to the period being evaluated by the user for planning purposes. In the example, the planning period runs from May 31, 2009 to Dec. 31, 2010. Lease characteristics 204 include information used to characterize the lease, such as region, site, property type, or status. Region refers to the geographical area where the leased property is located, such as the Northeast, Mid-Atlantic, South, Central, or West. Site refers to the particular leased property, such as an address of a building. Property type describes the type of property, for example, whether the property is an office space, an automatic teller machine (ATM), commercial property, residential property, multi-tenant property, or any other type of property. Status refers to whether the lease is new, active, expired, renewed, or other applicable status. Other examples of lease characteristics 204 include lease identifier, lease term, lease start date, lease end date, rentable area (e.g., square footage), rate (e.g., dollars per square foot), date of next rate increase, applicable fees, contact names, rent methodology, a master lease identifier indicating related leases, comments, and so on.

Expense data 206 describes base expenses and/or operating expenses associated with the lease. Expense data 206 may be represented on a periodic basis, such as monthly, quarterly, semi-annually, or annually, and may include actual expenses for an elapsed time period and/or forecasted expenses for a future time period. Actual expenses may be derived from data associated with active leases and recently expired leases (i.e., leases that were active during the relevant elapsed time period). Forecasted expenses may be derived from data associated with active leases, new leases, and/or renewed leases that are planned for the relevant future time period. The illustrated example reflects lease data available as of Jun. 1, 2009. Actual expenses populate months January to May 2009, and forecasted expenses populate June 2009 and beyond.

Planning data 208 includes data that user 135 may use to make planning decisions. In the example, planning data 208 describes the difference between the expenses for the current year and the forecasted expenses for the next year. In other embodiments, planning data 208 may compare the forecasted expenses to other data, such as target performance levels. Additionally, planning data 208 may track the effect of applying potential changes to lease data 164. Potential changes refer to proposed modifications requested by user 135 for evaluation and planning purposes. User 135 may evaluate the effect of a potential change in order to determine whether to implement the potential change. As an example, a potential change may comprise a potential rate change. In some embodiments, the potential rate change may refer to an increase or decrease to the rate according to a percentage, a fixed dollar amount, or other value. For example, a three percent increase to a lease having a rate of two dollars per square foot may be used to evaluate the effect of charging two dollars and six cents per square foot.

In some embodiments, planning data 208 may include an indicator indicating the results of performing an analysis. For example, the analysis may determine whether the forecasted expenses meet the target performance level, and the indicator may indicate that the target performance level has or has not been met. As another example, the analysis may evaluate multiple potential changes, and the indicator may indicate the one or more changes recommended for implementation.

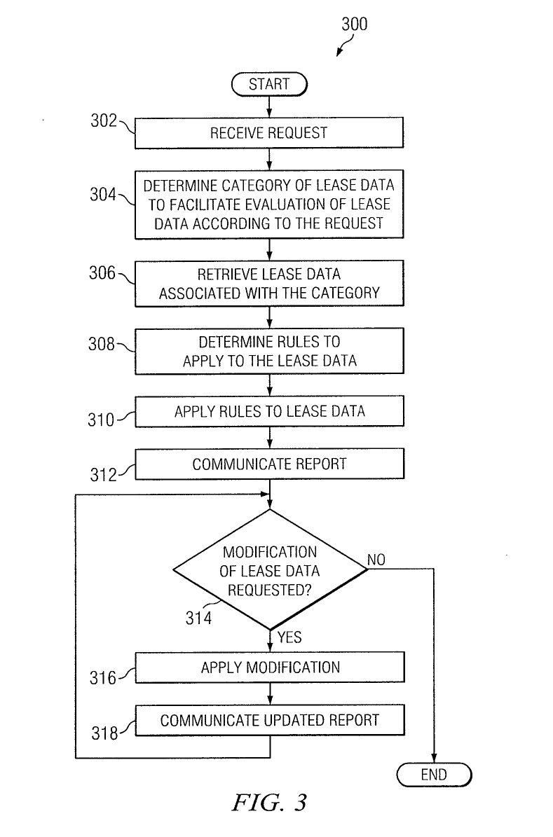

FIG. 3 illustrates a flowchart for lease evaluation and planning. The method begins at step 302 by receiving a request to facilitate an evaluation of lease data. The lease data comprises expenses associated with one or more leased properties. The request includes one or more categories that the user selects for evaluation. At step 304, the method determines one or more categories of lease data to facilitate evaluation of the lease data according to the request. Categories may be used to group a lease with other leases that share a common characteristic. As described with respect to FIG. 2, examples of categories include region, site, property type, status, rate, or any other categories.

The method retrieves lease data associated with the requested category at step 306. As an example, if the requested category requests lease data for a particular region, such as the Southern region, the method retrieves lease data associated with the category. In this example, the method retrieves the lease data for the one or more leases associated with the Southern region.

The method continues to step 308 to determine one or more rules to apply. The rules may indicate a category of lease data and an action to perform. Any suitable technique may be used to determine the rules to apply, for example, according to a category in the request, pre-configured criteria, or a combination of requested and pre-configured rules. Pre-configured rules may be customized for a particular enterprise, entity, line of business, user, and so on. In some embodiments, rules may be added, modified, or deleted as needed.

The method applies the rules at step 310. To apply the rules, the action may be performed on lease data associated with the category indicated by the rule. Examples of actions may be to include or exclude the subset of leases when preparing a report. Other actions may include sending notifications to a user or applying pre-determined modifications, such as normalization modifications, to the lease data. In some embodiments, each rule may be assigned a priority indicating the order in which it is to be applied.

At step 312, the method communicates a report. The report indicates the results of applying the rules. The report may include any suitable level of information, such as information for all leases or information filtered by site, region, property type, status, lease term, lease identifier, and/or other category. In some embodiments, the report may compare the lease performance to pre-determined target performance levels for actual and/or forecasted expenses.

The user may use the report to plan for future lease periods. If the forecasted data suggests that the target performance level will not be satisfied during the future lease period, the user may request a modification to evaluate. As an example, the user may request to evaluate a potential new lease. As another example, the user may request to evaluate a potential rate change. A lease rate describes charges associated with a unit of area, such as a monetary amount (e.g., dollars) per square foot, per square meter, per room, per floor of a building, per building, etc. A rate change refers to a modification to the rate, such as an increase or a decrease to the rate. In some embodiments, the rate change may be described in terms of a percentage or a specific monetary amount. A potential rate change refers to a rate change that a user wishes to evaluate. If the potential rate change yields a targeted level of performance, the user may select the potential rate change as the planned rate change. If the potential rate change fails to yield the targeted level of performance, the user may request a different potential rate change to evaluate whether the different potential rate change yields the target level of performance.

At step 314, the method detects whether a modification was requested. In some embodiments, the modification may be requested for particular categories of leases. For example, a potential rate change of 5% may be requested for lease data associated with leases categorized in the Western region. Requesting and applying modifications according to the categories, rather than lease-by-lease, may increase efficiency.

If a modification was requested, the method proceeds to step 316 to apply the modification. Applying the modification may include generating a record of the changed portion of the lease data, the user that requested the change, and the timestamp of the change. During a subsequent audit, the record may be included in an audit report to assist an auditor in reviewing the changes.

The method continues to step 318 to communicate an updated report indicating results of the modification. In some embodiments, the updated report may include a comparison to the results of the previous report to highlight the effect of the modification to the user. The method then returns to step 314 to determine whether another modification was requested. If no modification is requested at step 314, the method ends.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

What is claimed is:

1. A method, comprising:
receiving a request to facilitate an evaluation of lease data;
determining, by a processor, one or more categories of lease data according to the request;
retrieving the lease data associated with the determined categories;
determining one or more rules to apply to the lease data;
applying the one or more rules to the lease data; and
communicating a report indicating results of applying the one or more rules to the lease data.

2. The method of claim 1, further comprising:
receiving a request to modify the lease data;
applying the requested modification to the lease data; and
communicating an updated report indicating results of applying the requested modification.

3. The method of claim 1, further comprising:
receiving a request to modify the lease data, the modification comprising a potential rate change for a requested category of leases; and
applying the potential rate change to the lease data corresponding to the requested category of leases.

4. The method of claim 3, further comprising:
comparing the lease data with the potential rate change to the lease data without the potential rate change;
generating a comparison describing results of comparing the lease data with the potential rate change to the lease data without the potential rate change; and
communicating an updated report, wherein the updated report comprises results of applying the potential rate change and the comparison.

5. The method of claim 1, further comprising:
determining a priority for each rule of the one or more rules; and
wherein the applying the one or more rules further comprises applying the rules according to priority.

6. The method of claim 1, further comprising:
determining whether a change to the lease data has occurred; and
generating an audit report identifying a changed portion of the lease data if a change has occurred.

7. The method of claim 1, wherein at least one of the one or more rules normalizes the lease data according to fair market rent.

8. A non-transitory computer readable storage medium comprising logic, the logic, when executed by a processor, operable to:
receive a request to facilitate an evaluation of lease data;
determine one or more categories of lease data according to the request;
retrieve the lease data associated with the determined categories;
determine one or more rules to apply to the lease data;
apply the one or more rules to the lease data; and
communicate a report indicating results of applying the one or more rules to the lease data.

9. The computer readable storage medium of claim 8, further operable to:
receive a request to modify the lease data;
apply the requested modification to the lease data; and
communicate an updated report indicating results of applying the requested modification.

10. The computer readable storage medium of claim 8, further operable to:
receive a request to modify the lease data, the modification comprising a potential rate change for a requested category of leases; and
apply the potential rate change to the lease data corresponding to the requested category of leases.

11. The computer readable storage medium of claim 10, further operable to:
compare the lease data with the potential rate change to the lease data without the potential rate change;
generate a comparison describing results of comparing the lease data with the potential rate change to the lease data without the potential rate change; and
communicate an updated report, wherein the updated report comprises results of applying the potential rate change and the comparison.

12. The computer readable storage medium of claim 8, further operable to:
determine a priority for each rule of the one or more rules; and
wherein the applying the one or more rules further comprises applying the rules according to priority.

13. The computer readable storage medium of claim 8, further operable to:
determine whether a change to the lease data has occurred; and
generate an audit report identifying a changed portion of the lease data if a change has occurred.

14. The computer readable storage medium of claim 8, wherein at least one of the one or more rules normalizes the lease data according to fair market rent.

15. A system, comprising:
an interface operable to:
receive a request to facilitate an evaluation of lease data;
one or more processors operable to:
determine one or more categories of lease data according to the request;
retrieve the lease data associated with the determined categories;
determine one or more rules to apply to the lease data; and
apply the one or more rules to the lease data; and
the interface further operable to:
communicate a report indicating results of applying the one or more rules to the lease data.

16. The system of claim 15, further comprising:
the interface further operable to:
receive a request to modify the lease data;
the one or more processors further operable to:
apply the requested modification to the lease data; and
the interface further operable to:
communicate an updated report indicating results of applying the requested modification.

17. The system of claim 15, further comprising:
the one or more processors further operable to:
receive a request to modify the lease data, the modification comprising a potential rate change for a requested category of leases; and
apply the potential rate change to the lease data corresponding to the requested category of leases.

18. The system of claim 17, further comprising:
the one or more processors further operable to:
compare the lease data with the potential rate change to the lease data without the potential rate change; and
generate a comparison describing results of comparing the lease data with the potential rate change to the lease data without the potential rate change; and
the interface further operable to:
communicate an updated report, wherein the updated report comprises results of applying the potential rate change and the comparison.

19. The system of claim 15, the one or more processors further operable to:
determine a priority for each rule of the one or more rules; and
wherein the applying the one or more rules further comprises applying the rules according to priority.

20. The system of claim 15, the one or more processors further operable to:
determine whether a change to the lease data has occurred; and
generate an audit report identifying a changed portion of the lease data if a change has occurred.
